(19) United States
(12) Patent Application Publication
(10) Pub. No.: US 2025/0088408 A1
(43) Pub. Date: Mar. 13, 2025

(54) AUTOMATED NETWORK INCIDENT MANAGEMENT PLATFORM

(71) Applicant: RAKUTEN MOBILE, INC., Tokyo (JP)

(72) Inventor: Moataz RADY, Tokyo (JP)

(73) Assignee: RAKUTEN MOBILE, INC., Tokyo (JP)

(21) Appl. No.: 18/012,333

(22) PCT Filed: Nov. 10, 2022
(86) PCT No.: PCT/US2022/049481

§ 371 Date: Dec. 22, 2022

(51) Int. Cl. H04L 41/0631; H04L 41/0654; H04L 41/16; H04L 41/5074; H04L 43/08

(52) U.S. Cl. CPC H04L 41/0631; H04L 41/0654; H04L 41/16; H04L 41/5074; H04L 43/08

(57) ABSTRACT

A method and system of automatically and proactively managing incidents within a network. The method can include identifying a network issue based on a user service issue and received one or more network performance metrics. The method can also include correlating the identified network issue with one or more known network incidents to identify a relation between the network issue and the one or more known network incidents. The method can further include classifying the network issue within a database based on the correlation. The method may also include wherein the user service issue is based on at least one: call or service failure, call or service quality, or reduced network coverage. In addition, the method may include filtering the correlated network issue with the one or more known network incidents based on one or more conditions.

### BACKGROUND

### Technical Field

The present disclosure described herein relates to an automated network incident management platform.

### Background

Telecommunication customers and subscribers typically call customer support services or call centers to report and solve a network related service issue that the customer is experiencing using an operator's network. However, these call centers carry a very high operational costs for network service providers, including having live customer support agents speak to individual customers to address their network related issues and the costs associated with training such agents. Moreover, many customers may be displeased with the help that they receive from customer support agents, which may also related to lack of technical expertise, knowledge, or understanding of the problems by the agents. Currently, no procedure or automation exists within network service providers that can proactively detect, escalate, solve, and/or communicate to the customer about their issues, such as before a customer observes the service issue and calls the call center.

Hence, what is needed is an automated system and method of proactively detecting and resolving service issues and incidents within a network, and further keeping a customer notified of progress with respect to the service issue that is efficient, effective, reduces costs and network resources associated with managing customer support agents, reduces network downtime for customers and the operator, and further improves customer satisfaction with the service provider.

### SUMMARY

According to example embodiments, an automated system and method of proactively detecting and resolving service issues and incidents within a network is disclosed that can automatically and proactively keep a customer notified of progress with respect to a service issue that is efficient, effective, reduces costs and network computing resources associated with managing customer support agents, reduces network downtime for customers and the operator, and further improves customer satisfaction with the service provider, among other advantages. In addition, the method and system of the disclosure described herein can proactively open a communication channel (initiated by the operator) with customers and subscribers about the service issues they face (or may face in the future) in a live and interactive manner. In addition, various procedures can be provided in order reach an optimum goal or resolution of a service issue. Further, the method and system of the disclosure described herein can include user level auto Root Cause Analysis (RCA) and also automatically correlate procedures with network issues. Additional technical improvements for the system and method of the disclosure described herein can include improved efficiency between network components, automatically performing self-optimization and configuration of serving cells and neighboring cells to improve network coverage, bandwidth, and cell-to-cell handovers, thereby further minimizing costs and energy consumption, among other advantages.

In other exemplary embodiments, a method of managing incidents within a network is disclosed. The method can include identifying a network issue based on a user service issue and received one or more network performance metrics; correlating the identified network issue with one or more known network incidents to identify a relation between the network issue and the one or more known network incidents; and classifying the network issue within a database based on the correlation.

The method may further include wherein the user service issue is based on at least one: call or service failure, call or service quality, or reduced network coverage.

In addition, the method may include filtering the correlated network issue with the one or more known network incidents based on one or more conditions.

Further, the method may include performing root cause analysis (RCA) based on the step of filtering the correlated network issue with the one or more known network incidents.

Also, the method may include generating a support ticket based on the performed RCA.

Moreover, the method may include identifying a resolution with respect to the generated support ticket; and verifying the resolution.

In addition, the method may include notifying one or more users based on the classified network issue.

In addition, the method may include performing root cause analysis (RCA) based on artificial intelligence to identify any issue unrelated to the one or more known network incidents.

Further, the method may include wherein the step of correlating the identified network issue with the one or more known network incidents to identify a relation between the network issue and the one or more known network incidents further includes comparing a time of occurrence between the user service issue and the one or more known network incidents to determine a first match; and upon determining the first match, comparing a network impact type between the user service issue and the one or more known network incidents to determine a second match.

Also, the method may include wherein the step of performing RCA based on the step of filtering the correlated identified network issue with the one or more known network incidents further includes determining at least one of: serving cell coverage, serving cell quality, neighboring cell coverage, handover performance, or network media type.

In addition, the method may include querying one or more databases for a resolution based on the identified, correlated, and filtered network issue.

In other example embodiments, an apparatus for managing incidents within a network is disclosed, including a memory storage storing computer-executable instructions; and a processor communicatively coupled to the memory storage, wherein the processor is configured to execute the computer-executable instructions and cause the apparatus to identify a network issue based on a user service issue and received one or more network performance metrics; correlate the identified network issue with one or more known network incidents to identify a relation between the network issue and the one or more known network incidents; and classify the network issue within a database based on the correlation.

Also, the apparatus may include wherein the user service issue is based on at least one: call or service failure, call or service quality, or reduced network coverage.

In addition, the computer-executable instructions, when executed by the processor, may further cause the apparatus to filter the correlated network issue with the one or more known network incidents based on one or more conditions.

Further, wherein the computer-executable instructions, when executed by the processor, further cause the apparatus to perform root cause analysis (RCA) based on the step of filtering the correlated network issue with the one or more known network incidents.

Also, the computer-executable instructions, when executed by the processor, may further cause the apparatus to generate a support ticket based on the performed RCA.

Moreover, the computer-executable instructions, when executed by the processor, further cause the apparatus to identify a resolution with respect to the generated support ticket; and verify the resolution.

In addition, the computer-executable instructions, when executed by the processor, may further cause the apparatus to notify one or more users based on the classified network issue.

In addition, the computer-executable instructions, when executed by the processor, may further cause the apparatus to perform root cause analysis (RCA) based on artificial intelligence to identify any issue unrelated to the one or more known network incidents.

Further, the apparatus may include wherein the step of correlating the identified network issue with the one or more known network incidents to identify a relation between the network issue and the one or more known network incidents, and wherein the computer-executable instructions, when executed by the processor, may further cause the apparatus to compare a time of occurrence between the user service issue and the one or more known network incidents to determine a first match; and upon determining the first match, comparing a network impact type between the user service issue and the one or more known network incidents to determine a second match.

Also, the apparatus may include wherein the step of performing RCA based on the step of filtering the correlated network issue with the one or more known network incidents, and wherein the computer-executable instructions, when executed by the processor, may further cause the apparatus to determine at least one of: serving cell coverage, serving cell quality, neighboring cell coverage, handover performance, or network media type.

In other example embodiments, a non-transitory computer-readable medium including computer-executable instructions for managing incidents within a network by an apparatus is disclosed, wherein the computer-executable instructions, when executed by at least one processor of the apparatus, cause the apparatus to identify a network issue based on a user service issue and received one or more network performance metrics; correlate the identified network issue with one or more known network incidents to identify a relation between the network issue and the one or more known network incidents; and classify the network issue within a database based on the correlation.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture of the automated network incident management platform method and system of the disclosure described herein according to one or more embodiments;

FIG. 2 illustrates a diagram of a process flow and various modules for the automated network incident management platform method and system of the disclosure described herein according to one or more embodiments;

FIG. 3 illustrates a diagram of a process flow for a correlation engine module of the automated network incident management platform method and system of the disclosure described herein according to one or more embodiments; and

FIG. 4 illustrates a diagram of a process flow for an RCA module of the automated network incident management platform method and system of the disclosure described herein according to one or more embodiments.

### DETAILED DESCRIPTION

The following detailed description of example embodiments refers to the accompanying drawings. The same reference numbers in different drawings may identify the same or similar elements.

The foregoing disclosure provides illustrations and descriptions, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

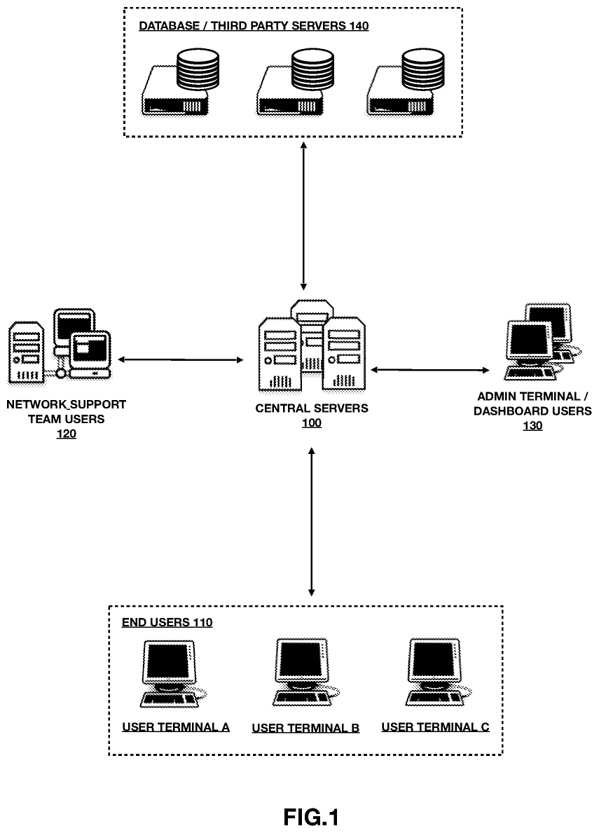

FIG. 1 illustrates a diagram of a general network architecture according to one or more embodiments. Referring to FIG. 1, end users 110, network support team users 120, and admin terminal/dashboard users 130 (collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the disclosure described herein according to one or more embodiments. Here, users 110 can be any type of customer, network service provider agent, or vendor, among others, of a network or telecommunication service provider, such as users operating computing devices and user terminals A, B, and C. Each of users 110 can communicate with servers 100 via their respective terminals or portals, wherein servers 110 can provide or automatically operate the network impact prediction engine system and method of the disclosure described herein. Users 120 can include application development members or support agents of the network service provider for developing, integrating, and monitoring the automated network incident management platform method and system of the disclosure described herein, including assisting, scheduling/modifying network events, and providing support services to end users 110. Admin terminal/dashboard users 130 may be any type of user with access privileges for accessing a dashboard or management portal of the disclosure described herein, wherein the dashboard portal can provide various user tools, GUI information, maps, open/closed/pending support tickets, graphs, and customer support options. It is contemplated within the scope of the present disclosure described herein that any of users 110 and 120 may also access the admin terminal/dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data, such as current, real-time, and past network related historical and KPI data, may be stored thereon and retrieved therefrom for network analysis, RCA, artificial intelligence (AI) processing, neural network models, machine learning, predictions, and simulations by servers 100. However, it is contemplated within the scope of the present disclosure described herein that the service management platform method and system of the disclosure described herein can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a trans-mitter component, and/or a transceiver component. The communication interface may enable one or more of servers or terminals of elements 100-140 to establish connections and/or transfer communications with other devices (e.g., a server, another device). The communications may be ena-bled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metro-politan area network (MAN), a private network, an ad hoc network, an intranet, the Internet, a fiber optic-based network, a cellular network (e.g., a fifth generation (5G) network, sixth generation (6G) network, a long-term evolution (LTE) network, a third generation (3G) network, a code di-vision multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like. It is understood that other embodiments are not limited thereto, and may be implemented in a variety of different architectures (e.g., bare metal architecture, any cloud-based architecture or deployment architecture such as Kubernetes, Docker, OpenStack, etc.).

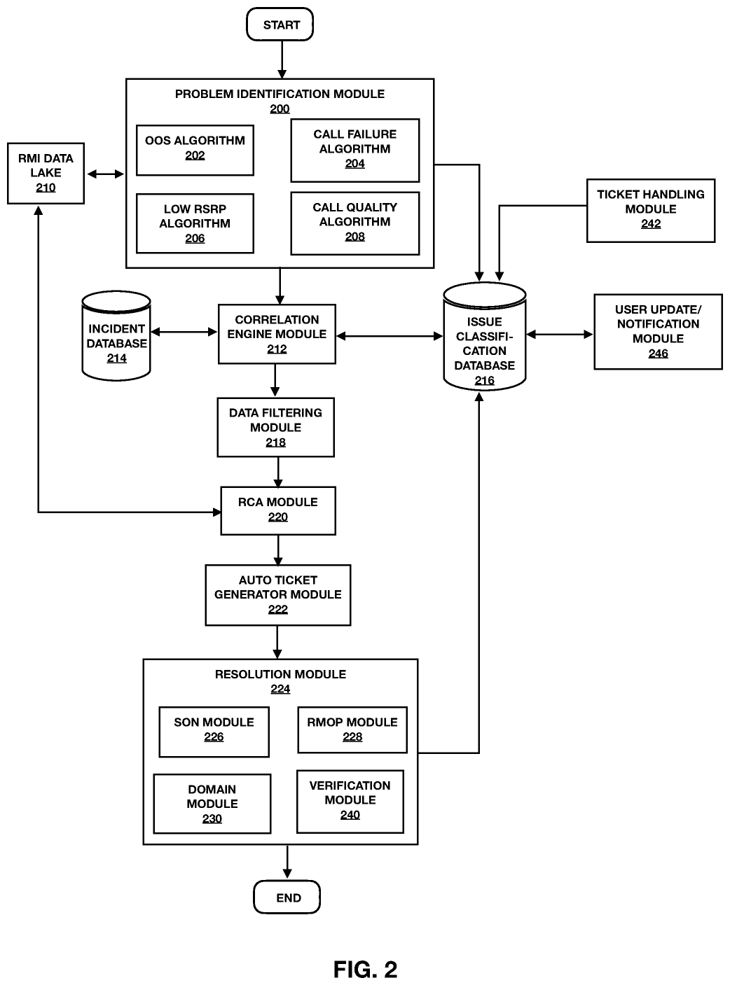

FIG. 2 illustrates a process flow and various modules for the automated network incident management platform method and system of the disclosure described herein according to one or more exemplary embodiments. Here, the process can begin by a problem identification module 200 receiving a reported service issue or problem from a customer or user of a network, such as a service issue pertaining to network coverage or connectivity (or lack thereof). Alternatively, module 200 can automatically detect any network related problem/issues without user intervention or user reporting, such as through continuous diagnostic testing of the network and the output of any one or more of sub-modules 202-208. In particular, the problem identification module 200 can include various sub-modules for applying various algorithms and logic to help further identify the user's service issues or problems or potential future user service level issues within an service providers network. These sub-modules can include an Out of Service (OOS) algorithm sub-module 202 for identifying if users lose network connectivity, and if so, its duration, a call failure algorithm sub-module 204 for detecting and identifying dropped network calls and/or call connectivity issues, a low Reference Signal Received Power (RSRP) algorithm sub-module 206 for detecting and identifying low or inferior signal levels and signal quality levels, and a call quality algorithm sub-module 208 for detecting and identifying call quality issues within the network.

Still referring to FIG. 2, each identified issue or problem can be associated with a specific customer or user of the network, including the time of day the issue was reported, the user's location, and the user's device or equipment, among others. In addition, the problem identification module 200 may also send and receive network related issues/problems from a Remote Method Invocation (RMI) data lake module 210, which can include a system or central repository of various types of structured, semi structured, or unstructured network data, such as network performance data and Key Performance Indicator's (KPI's), which may be stored and retrieved therefrom by module 210 to assist with analyzing and identifying the network problem.

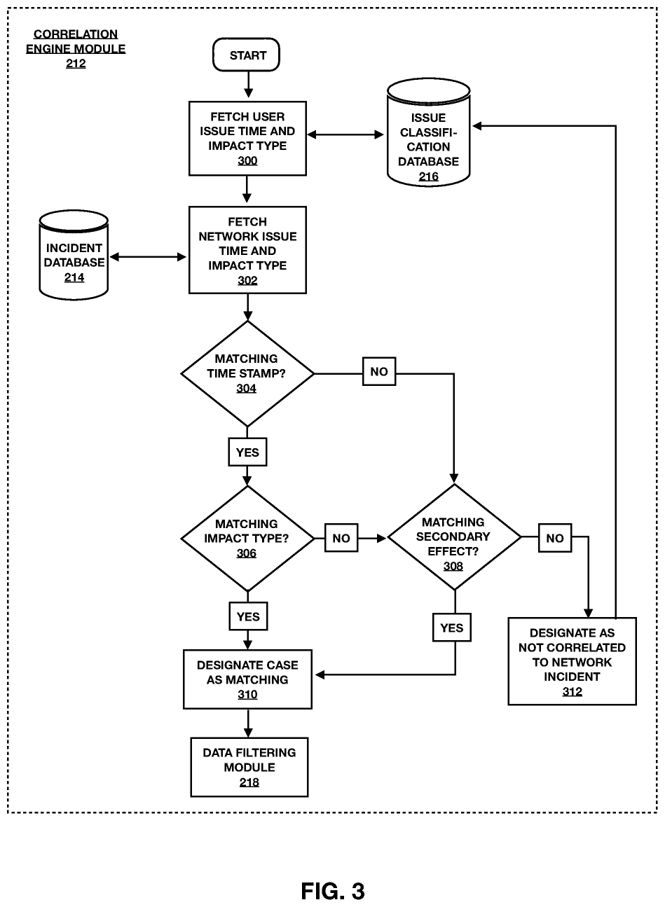

Still referring to FIG. 2, after the network issue/problem has been identified by module 200, the system can then proceed to a correlation engine module 212, wherein the correlation engine module 212 will be described in more detail with respect to FIG. 3. Here, the correlation engine module 212 can be in bi-directional communication a network incident database 214. Here, incident database 214 can include information and data pertaining to known network related incidents, issues, or problems, such as known geographics areas having low RSRP or no coverage, down network, nodes, and telecommunication lines, or malfunctioning cells, radio towers, switches, and network components, among others. The correlation engine module 212 can determine if an identified customer problem from module 200 is related to or correlated to a known network incident from database 214. Here, database 214 can include data such as incident start/end date and time, a list of affected International Mobile Subscriber Identities (IMSI's), if there is an impact to service, type of impact (e.g., down voice service, network/internet service, etc.), related open/closed ticket status, if there is an expected secondary effect, and duration of the secondary effect and type(s) of effect. For example, if it is known from database 214 that a particular network node at a specific geolocation is down or inoperable, and an identified network problem/issue is related to that particular node, then the system of the disclosure described herein can classify the network problem/issue as being known, addressed, or pending a resolution, and further report it to an issue classification database 216 (i.e., issue classification per IMSI), in lieu of proceeding to module 218.

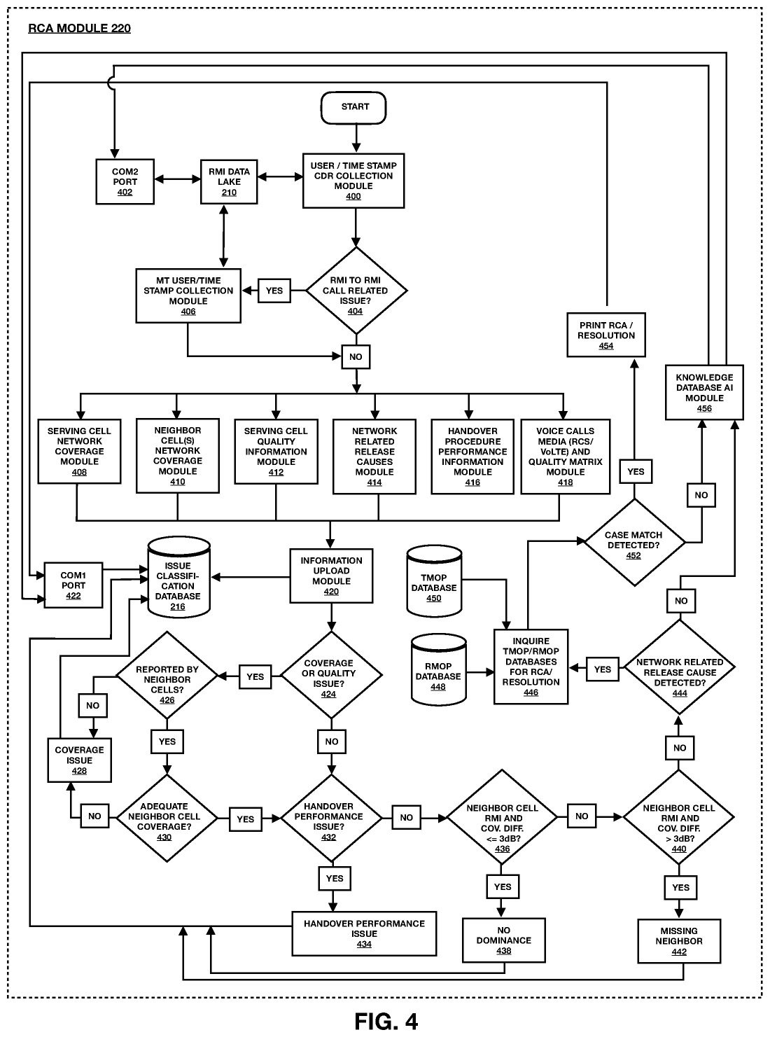

Still referring to FIG. 2, in such a scenario, the system can send an update or notification to one or more users via module 246 that the network is aware of the service problem/issue and it is being currently addressed or is resolved, among other notifications. In particular, the foregoing approach in automatically and proactively notifying customers or users of a network with respect to a network issue can help to eliminate or minimize customer or user reports or complaints to a call center, among other advantages. Still referring to FIG. 2, in the event that the correlation module 212 cannot correlate or associate a network issue with a known network incident, then the system can proceed to a data filtering module 218. Here, filtering module 218 can help to further provide a smaller and more accurate list of users (or potential users) being affected by the identified network problem. For example, module 218 can include certain conditions or criteria's, such as filtering for, identifying, and including users that 1) do not correlate to a known network incident, 2) a network problem that still persists despite a ticket status indicating the problem being closed/addressed, and/or 3) a network problem still that persists in general. Next, the filtered list of one or more users and network problems can then be sent to a Root Cause Analysis (RCA) module 220, wherein the RCA module 220 will be described in more detail with respect to FIG. 4. Next, the output, recommendation, or suggestion of the RCA module can then be sent to an auto ticket generator module 222 for automatically creating a ticket (or a trouble/support ticket) for the user with respect to the network service problem/issue.

Still referring to FIG. 2, the auto generated ticket can then be sent to a resolution module 224, wherein the resolution module 224 is adapted to automatically identify and verify a resolution to the network problem/issue. In particular, resolution module 224 can include a Self-Organizing Network (SON) module 226 for automating and initiating a resolution to the network problem/issue, such as via automated self-configuration, self-optimization, self-healing, and self-protection functions and operations. For example, if a user has a coverage related issue or problem, then the SON module 206 can decide to increase power to a radio tower, cell, and/or to the user, and the system can then verify (via verification module 240) if the user's problem has been addressed, and if so, then the user will be notified, and if not, then the system can notify a domain module 230 of an existing problem (to be handled by a live support agent). In particular, verification module 240 can allow the foregoing process with respect to modules 200-224 to run in a continuous loop to determine if the problem has been resolved, such as operating problem identification module 220 and its associated sub-modules 202-208 to identify if the problem continues to exist. If the problem cannot be resolved (such as via the SON module automatically making network adjustments to the network), then the domain module 230 can be notified. Here, the domain module 230 may include active customer support agents that can manually open a ticket to address the user or network problem and may also be in communication with a ticket handling module 242.

Still referring to FIG. 2, module 224 can also include a Resolution Method of Procedures (RMOP) module 228. Here, the RMOP module can include auto scripts which can contain a Method of Procedure (MOP) to resolve various network related issues. These auto scripts can run or execute the MOP automatically without human intervention, whereby an automated system trigger, event, or condition can automatically execute the auto scripts. Alternatively, the auto scripts may also be initiated or triggered manually, such as via a network agent requesting the auto script to run. In the current embodiment, the system can automatically ask or request a user or agent to run one or more auto scripts based on one or more identified problems.

Still referring to FIG. 2, next, the output of the resolution module 224 (whether the problem is resolved or not) is then sent to the issue classification database 216, where each issue/problem is classified per IMSI. In particular, database 216 is contemplated within the scope of the present disclosure described herein to include various types information about a user, such as background information on the user and the network service problem/issue, the specific problem/issue the user has incurred, the date/time the user incurred the network problem/issue, and the outcome of the RCA with respect to the problem/issue, among others. Further, the output and result of the resolution module 224 can be sent to the user via notification module 246, such as whether the problem/issue has been resolved, is being currently addressed, cannot be resolved, and/or providing various suggestions or recommendations to the user for resolving the problem/issue, among others. In addition, the handling module 242 can also update database 216 as various open, closed, or pending tickets with respect to one or more users.

FIG. 3 illustrates a diagram of a process flow for a correlation engine module of the automated RCA platform method and system of the disclosure described herein according to one or more exemplary embodiments. Here, the process of the correlation engine module 212 can begin at step 300, wherein the system can fetch or retrieve the time and type of impact with respect to the problem/issue incurred by the user (or to be incurred by the user). Here, module 212 can retrieve the foregoing information from the issue classification database 216. Next, at step 302, the system can further fetch or retrieve the one or more time and type of impact information with respect to known issues, problems, or incidents incurred by the network from the incident database 214, or in the alternative, obtain a list of such incidents from incident database 214. Next, at step 304, the process can determine if the time stamps (or a time of occurrence) from the user service issues from database 216 match with the time stamps from the known network incidents from incident database 214.

Still referring to FIG. 3, if there is a match, then the system can proceed to step 308, if there is no match, then the process can proceed to step 306. At step 306, the process can further determine if the type of impact (e.g., call failure) also match between the user service problem/issue and the known network incidents, and if yes, then the process can proceed to step 310, and if no, then the process can proceed to step 308. At step 308, the process can determine if there any one or more secondary effects match from the user reported issue and the known network incidents, and if yes, then the process can proceed to step 310, and if no, then the process can proceed to step 312. In particular, the system can designate or mark the issue related case as a match and send this output to the data filtering module 218 (FIG. 2), or in the alternative, the system can designate the problem/issue as not being correlated to a network incident and send this output to the issue classification database 216 (FIG. 3). For example, an identified problem can be related to authentication failure within the network which can affect user accessibility. Thus, for this example, its secondary effect can include the user not being able to receive calls. Still referring to this example, even if the authentication issue is resolved and the user is able to connect to the network, they might still not able to receive calls. Hence, while the main authentication problem may be resolved, the secondary effect continues and the user may still have an issue with not receiving calls.

FIG. 4 illustrates a diagram of a process flow for an RCA module of the automated RCA platform method and system of the disclosure described herein according to one or more embodiments. Here, the process for the RCA module 220 can begin at a user/time stamp Call Detail Record (CDR) collection module 400, wherein module 400 can include user and time stamp information related to the problem/issue, which can further include information related to network performance data (such as KPI's) retrieved from the RMI data lake module 210. Next, at step 404, the system can determine whether RMI to RMI is a call related issue, and if yes, then the process can proceed to the Mobile Terminating (MT) user/time stamp collection module 406, and if no, then the process can proceed to modules 408-418. Here, If two RMI users are calling each other, then the calling party can be referred to as the Mobile Originating (MO) and the receiving party can be referred to as the MT. In this scenario, both the MO and MT information would be needed since the network problem can occur at either the MO or MT side. Accordingly, step 404 includes the step of requesting any missing information such that the system can analyze both the calling user and the call receiving user to understand the source of the problem (i.e., the MT or MO) and what the problem entails.

Still referring to FIG. 4, each of modules 408-418 can operate in unison or in parallel. In particular, a serving cell network coverage module 408 can determine if a serving cell is providing adequate network coverage, a neighbor cell(s) network coverage module 410 can determine if neighboring cells (to a serving cell) are providing adequate network coverage, a serving cell quality information module 412 can retrieve data with respect to the quality of service provided by the serving cell (e.g., transmission or reception quality), a network related release causes module 414 can identify network related release causes. Here, a release cause can generally relate to a network releasing user connectivity or replying to user connectivity with messages (wherein such messages may include failure messages). Accordingly, release causes can indicate that a problem has occurred with respect to a user. Further, a handover procedure performance information module 416 can also be provided for identifying, determining, and managing cell-to-cell handovers and their performance, and a voice calls media (RCS/VoLTE) and quality matrix module 418 for determining the type of media being used or transmitted and its associated quality. Next, the output of each module 408-418 can be aggregated and sent to an information upload module 420 for uploading the aggregated network data to the issue classification database 216.

Still referring to FIG. 4, from the aggregated network data as input, at step 424, the system can determine if the problem/issue is coverage or quality related, and if it is either, then it can proceed to step 426, and if it is neither, then the process can proceed to step 432. At step 426, the system can determine if the problem/issue was reported by one or more neighboring cells, and if no, then the system proceeds to step 428 where the issue is designated or identified as a coverage issue and uploaded to the issue classification database 216, and if yes, the system proceeds to step 430. At step 430, the system can determine if one or more neighboring cells providing adequate cell coverage (such as based on a pre-defined threshold or condition), and if no, then the system proceeds to step 428 where the problem/issue is designated or identified as a coverage issue and uploaded to the issue classification database 216, and if yes, the system proceeds to step 432. At step 432, the system can determine if the problem/issue is related to handover performance between cell-to-cell, and if yes, then the system proceeds to step 434 where the problem/issue is designated or identified as a handover performance issue and uploaded to the issue classification database 216, and if no, then the system can proceed to step 436. At step 436, the process can determine whether a neighboring cell RMI and coverage differential is less than or equate to 3db (or any predefined threshold or criteria), and if yes, then the system proceeds to step 438 where the problem/issue is designated or identified as the serving cell or neighboring cell having no dominance and uploaded to the issue classification database 216, and if no, then the system proceeds to step 440. As an example, a serving cell or neighbor cell may be serving where it's not supposed to be. Still referring ot this example, then based on user location, sites(s), cell locations, and site foot print, the system can determine which cell is not supposed to be serving an area and based on that decision the system could increase power/decrease power, uptilt/downtilt, and re-azimuth, or re-configure a specific cell. At step 440, the process can determine whether the neighboring cell RMI and coverage differential is greater than 3 dB (or any predefined threshold or criteria), and if yes, then the system proceeds to step 442 where the problem/issue is designated or identified as a missing neighbor cell to the serving cell and uploaded to the issue classification database 216, and if no, then the system can proceed to step 444.

Still referring to FIG. 4, at step 444, the system can determine if a network related release cause is detected, and if no, then the system can proceed to the knowledge database AI module 456, and if yes, then the system can proceed to step 446. At step 446, the system can inquire (or query) a Troubleshooting Method of Procedure (TMOP) database 450 (e.g., a database where problems descriptions and network symptoms are stored and which is able to reach RCA for network related problems, among other functions) and an RMOP database 448 (e.g., a database where scripts to solve network issues are stored with respect to MOP, and a database where MOP's are stored based on problem descriptions, among other functions) for an RCA or resolution of the issue. Here, the output of the inquiry (or query) of databases 448 and 450 can then be sent to step 452 or decision module 452. At step or decision module 452, the system can determine if a case match is detected, or a prior case is identified having the same or similar issues/problems (or characteristics) and associated parameters and what the RCA or resolution of that prior case was. At step 452, if the foregoing case match is detected, then the RCA or resolution for the active user case is then printed at step 454 and sent to a communication interface port 422 (COM1), which further sends and uploads the RCA or resolution to the issue classification database 216. Referring back to knowledge database AI module 456, module 456 can be a repository such as a knowledge storage or knowledge base repository (e.g., of an enterprise application platform). In addition, module 456 can perform any type of AI, machine learning, or neural network modeling and analysis within the knowledge repository for obtaining a resolution for an problem/issue. Further, module 456 (which can include Auto-RCA) can identify any issue, even if it's not related to known issues such as serving cell coverage, serving cell quality, neighboring cell coverage, handover performance, or network media type. For example, in some cases, the AI of module 456 can be used to address possible issues that may come from software bugs in the network, or network malfunctioning, among others. Here, the output data of module 456 (such as with respect to resolution of the issue) can then be sent to a communication port interface 402 (COM2), which further sends and uploads the data to the RMI data lake module 210.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, microservice(s), segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of managing incidents within a network, the method comprising:
identifying a network issue based on a user service issue and received one or more network performance metrics;
correlating the identified network issue with one or more known network incidents to identify a relation between the network issue and the one or more known network incidents; and
classifying the network issue within a database based on the correlation.

2. The method of claim 1, wherein the user service issue is based on at least one: call or service failure, call or service quality, or reduced network coverage.

3. The method of claim 1, further comprising:
filtering the correlated network issue with the one or more known network incidents based on one or more conditions.

4. The method of claim 3, further comprising:
performing root cause analysis (RCA) based on the step of filtering the correlated network issue with the one or more known network incidents.

5. The method of claim 4, further comprising:
generating a support ticket based on the performed RCA.

6. The method of claim 5, further comprising:
identifying a resolution with respect to the generated support ticket; and
verifying the resolution.

7. The method of claim 1, further comprising:
performing root cause analysis (RCA) based on artificial intelligence to identify any issue unrelated to the one or more known network incidents.

8. The method of claim 1, wherein the step of correlating the identified network issue with the one or more known network incidents to identify a relation between the network issue and the one or more known network incidents further comprises:
comparing a time of occurrence between the user service issue and the one or more known network incidents to determine a first match; and
upon determining the first match, comparing a network impact type between the user service issue and the one or more known network incidents to determine a second match.

9. The method of claim 4, wherein the step of performing RCA based on the step of filtering the correlated identified network issue with the one or more known network incidents further comprises determining at least one of: serving cell coverage, serving cell quality, neighboring cell coverage, handover performance, or network media type.

10. The method of claim 4, further comprising:
querying one or more databases for a resolution based on the identified, correlated, and filtered network issue.

11. An apparatus for managing incidents within a network, comprising:
a memory storage storing computer-executable instructions; and
a processor communicatively coupled to the memory storage, wherein the processor is configured to execute the computer-executable instructions and cause the apparatus to:
identify a network issue based on a user service issue and received one or more network performance metrics;
correlate the identified network issue with one or more known network incidents to identify a relation between the network issue and the one or more known network incidents; and
classify the network issue within a database based on the correlation.

12. The apparatus of claim 11, wherein the user service issue is based on at least one: call or service failure, call or service quality, or reduced network coverage.

13. The apparatus of claim 11, wherein the computer-executable instructions, when executed by the processor, further cause the apparatus to:
filter the correlated network issue with the one or more known network incidents based on one or more conditions.

14. The apparatus of claim 13, wherein the computer-executable instructions, when executed by the processor, further cause the apparatus to:
perform root cause analysis (RCA) based on the step of filtering the correlated network issue with the one or more known network incidents.

15. The apparatus of claim 14, wherein the computer-executable instructions, when executed by the processor, further cause the apparatus to:
generate a support ticket based on the performed RCA.

16. The apparatus of claim 15, wherein the computer-executable instructions, when executed by the processor, further cause the apparatus to:
identify a resolution with respect to the generated support ticket; and
verify the resolution.

17. The apparatus of claim 11, wherein the computer-executable instructions, when executed by the processor, further cause the apparatus to:
perform root cause analysis (RCA) based on artificial intelligence to identify any issue unrelated to the one or more known network incidents.

18. The apparatus of claim 11, wherein the step of correlating the identified network issue with the one or more known network incidents to identify a relation between the network issue and the one or more known network incidents, and wherein the computer-executable instructions, when executed by the processor, further cause the apparatus to:
compare a time of occurrence between the user service issue and the one or more known network incidents to determine a first match; and
upon determining the first match, comparing a network impact type between the user service issue and the one or more known network incidents to determine a second match.

19. The apparatus of claim 14, wherein the step of performing RCA based on the step of filtering the correlated network issue with the one or more known network incidents, and wherein the computer-executable instructions, when executed by the processor, further cause the apparatus to determine at least one of: serving cell coverage, serving cell quality, neighboring cell coverage, handover performance, or network media type.

20. A non-transitory computer-readable medium comprising computer-executable instructions for managing incidents within a network by an apparatus, wherein the computer-executable instructions, when executed by at least one processor of the apparatus, cause the apparatus to:
identify a network issue based on a user service issue and received one or more network performance metrics;
correlate the identified network issue with one or more known network incidents to identify a relation between the network issue and the one or more known network incidents; and
classify the network issue within a database based on the correlation.
